(19) United States
(12) Patent Application Publication
(10) Pub. No.: US 2009/0179867 A1
(43) Pub. Date: Jul. 16, 2009

(54) METHOD FOR PROVIDING USER INTERFACE (UI) TO DISPLAY OPERATING GUIDE AND MULTIMEDIA APPARATUS USING THE SAME

(75) Inventors: Jung-hyun SHIM, Seononam-si (KR); Nho-Kyung Hong, Seoul (KR); Hyun-ki Kim, Seoul (KR); Eun-kyung Yoo, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/172,610

(22) Filed: Jul. 14, 2008

(30) Foreign Application Priority Data
Jan. 11, 2008 (KR) 2008-3462

(51) Int. Cl. G06F 3/041

(52) U.S. Cl. 345/173

(57) ABSTRACT

According to a method of providing a user interface (UI), and a multimedia apparatus using the same, if a user touches a touch screen, a guide representing functions to be performed according to a user's operation is displayed. Therefore, a user can use the touch screen more conveniently.

### CROSS-REFERENCE TO RELATED APPLICATION

This application claims the benefit of Korean Patent Application No. 2008-3462, filed Jan. 11, 2008 in the Korean Intellectual Property Office, the disclosure of which is incorporated herein by reference.

### BACKGROUND OF THE INVENTION

1. Field of the Invention

Aspects of the present invention relate to a method for providing a user interface (UI) and a multimedia apparatus using the same, and more particularly, to a method for providing a UI in which a user selects a desired function using a touch screen, and a multimedia apparatus using the same.

2. Description of the Related Art

Multimedia apparatuses such as MPEG-1 audio layer 3 (MP3) players, have a strong connection with users. Therefore, such multimedia apparatuses are fabricated for users to use conveniently. To provide convenience to the user, the multimedia apparatuses generally include a display and provide a user interface (UI) as a graphical user interface (GUI).

A conventional GUI method uses a pointer to select items such as icons or menus. A user uses input devices, such as a mouse or touch screen, to input commands using the GUI. The user selects desired content using the input devices and is able to use the content.

A touch screen receives user operations input when a user touches buttons displayed on a screen. The user of such a touch screen may thus use a UI more intuitively. However, although various input methods are provided to the touch screen, the touch screen does not differently display the function to be performed according to the input methods. Accordingly, a user should memorize the functions performed according to the methods for inputting the touch screen.

As such, a user requires a more convenient interface, and thus a method which allows a user to conveniently use a touch screen is required.

### SUMMARY OF THE INVENTION

Aspects of the present invention relate to a method for providing a user interface (UI), which displays a guide for functions performed according to user operations and which enables a user to use a touch screen more conveniently. Additional aspects and/or advantages of the invention will be set forth in part in the description which follows, and in part, will be obvious from the description, or may be learned by practice of thee invention.

According to an aspect of the present invention, there is provided a method for providing a user interface (UI), including receiving a user touch on a touch screen; and displaying an operating guide which represents functions performed according to the user's touch on the touch screen if the user touch is received.

According to aspects of the present invention, the operating guide may represent functions performed according to the direction in which a user flicks the touch screen.

According to aspects of the present invention, the direction may be one of up, down, left, and right directions.

According to aspects of the present invention, the displaying may include displaying the operating guide at an area corresponding to where the touch screen is touched.

According to aspects of the present invention, the displaying may include displaying the operating guide on the touch screen while the touch screen is touched.

According to aspects of the present invention, the method may further include performing a function corresponding to a predetermined direction, if a user flicks the touch screen in the predetermined direction.

According to aspects of the present invention, the method may further include causing the operating guide to disappear, if the user releases his or her finger from the touch screen.

According to aspects of the present invention, the operating guide may represent functions which are capable of being performed in a current mode of an application.

According to an aspect of the present invention, there is provided a multimedia apparatus, including a touch screen to display a user interface, and to receive a user touch; and a control unit to control the touch screen in order to display an operating guide which represents functions performed according to a user's touch if the user touch is received on the touch screen.

According to aspects of the present invention, the operating guide may represent functions performed according to the direction in which a user flicks the touch screen.

According to aspects of the present invention, the direction may be one of up, down, left, and right directions.

According to aspects of the present invention, the control unit may control the touch screen to display the operating guide corresponding to an area in which the touch screen is touched.

According to aspects of the present invention, the control unit may control the touch screen to display the operating guide while touch screen is touched.

According to aspects of the present invention, if a user flicks the touch screen in a predetermined direction, the control unit may control the touch screen to perform a function corresponding to the predetermined direction.

According to aspects of the present invention, if the user releases his or her finger from the touch screen, the control unit may cause the operating guide to disappear.

According to aspects of the present invention, the operating guide may represent functions which are capable of being performed in a current mode of an application.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an MPEG-1 audio layer 3 (MP3) player according to an exemplary embodiment of the present invention;

FIG. 2 is a flowchart illustrating the process of providing an operating guide according to an exemplary embodiment of the present invention;

FIGS. 3A to 3I are a diagrams illustrating the touch operations of a touch screen according to aspects of the present invention;

FIG. 4 is a view illustrating a touch screen prior to being touched according to an exemplary embodiment of the present invention;

FIG. 5 is a view illustrating a touch screen displaying an operating guide according to an exemplary embodiment of the present invention;

FIG. 6 is a view illustrating a touch screen displaying an operating guide according to an exemplary embodiment of the present invention; and

FIG. 7A to 7D are views illustrating the process of operating a touch screen according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to like elements throughout. The embodiments are described below, in order to explain the present invention by referring to the figures.

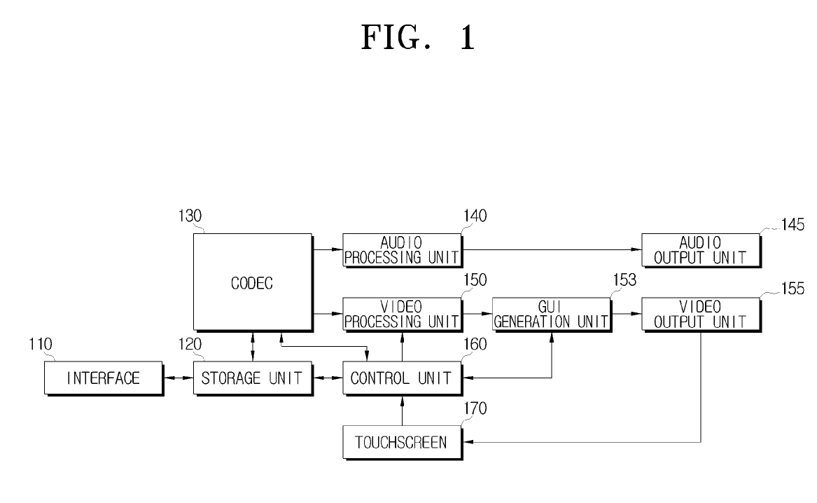

FIG. 1 is a block diagram illustrating an MPEG-1 audio layer 3 (MP3) player according to an exemplary embodiment of the present invention. Referring to FIG. 1, an MP3 player may include an interface 110, a storage unit 120, a codec 130, an audio processing unit 140, an audio output unit 145, a video processing unit 150, a graphical user interface (GUI) generation unit 153, a video output unit 155, a control unit 160, and a touch screen 170. Although described herein as an MP3 player, aspects of the present invention are not limited thereto such that aspects of the present invention may be applied to any touch screen device, such as a personal, laptop, or tablet computer having a touch screen, a phone, or other handheld or mobile device having a touch screen. Further, the encoding is not limited to MP3 but can be unencoded content or content encoded using other coding techniques, such as AAC. Moreover, the multimedia device can have other elements in addition to or instead of the shown elements, such as video encoders and decoders, buttons, optics of use in capturing images, etc.

The interface 110 enables the MP3 player to access a computer. The MP3 player downloads a multimedia file stored on a computer via the interface 110, and uploads a multimedia file to the computer via the interface 110. According to aspects of the present invention, the interface 110 is not limited to accessing a computer as the interface 110 may provide connectivity to wired or wireless networks, cellular networks, other MP3 players, handheld devices, cellular phones, peripheral devices on a network, and the like.

The storage unit 120 of the MP3 player may store multimedia files, such as music files, video files, text files, or the like. The storage unit 120 may store operational programs to operate the MP3 player. Further, according to aspects of the present invention, the storage unit 120 may further include executable programs or code other than the operation programs, such as widgets, third-party programs and functions, or internet executable programs and can comprise removable and/or internal memory.

The codec 130 compresses or decompresses multimedia files. Specifically, the codec 130 decompresses multimedia files stored in the storage unit 120, and transmits the decompressed multimedia files to the audio processing unit 140 or the video processing unit 150. The codec 130 may encode raw content to be stored in the storage unit 120 in other aspects of the present invention.

The audio processing unit 140 processes audio signals transmitted from the codec 130. For example, the audio processing unit 140 processes audio signals by performing noise reduction, equalization, or the like, and transmits the processed audio signal to the audio output unit 145. The audio output unit 145 outputs audio transmitted from the audio processing unit 140 through a speaker, headphone, or other audio output connected to an external output terminal.

The video processing unit 150 processes a video signal transmitted from the codec 130 by performing video scaling or the like. The video processing unit 150 transmits the processed video signal to the GUI generation unit 153. The GUI generation unit 153 generates a GUI to be displayed on a display (such as the touch screen 120) and combines the generated GUI with video transmitted from the video processing unit 150. The video output unit 155 displays video combined with the GUI output from the GUI generation unit 153 on the touch screen 170 or outputs the video to an external apparatus connected to an external output terminal (not shown). The touch screen 170 displays video output from the video output unit 155. The touch screen 170 receives a touch operation from a user and transmits the touch operation to the control unit 160.

The control unit 160 recognizes user commands according to the user's touch operation transmitted through the touch screen 170, and controls the overall operation of the MP3 player according to the user commands. Further, the control unit 160 recognizes user commands other than the touch operation, such as input commands input through a mouse, a keyboard, a microphone (i.e., for vocal commands), and the like.

If a user touches the touch screen 170, the control unit 160 controls the touch screen 170 to display an operating guide which provides information on the functions performed according to a user's operation. The operating guide provides information on specific functions which may be performed using the touch screen 170. Specifically, the operating guide provides assistance to the user on how to use the touch screen 170.

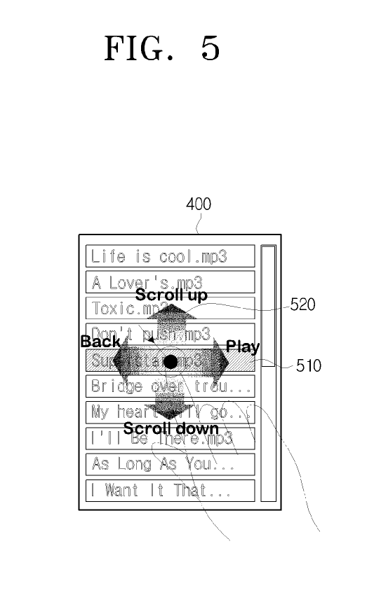

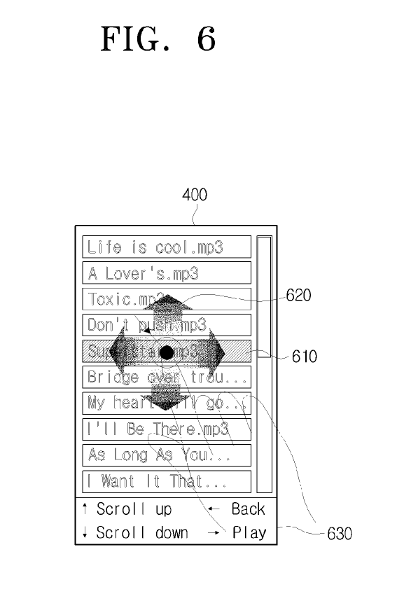

The control unit 160 displays the operating guide on the touch screen 170 while a user touches the touch screen 170 with his or her finger. The control unit 160 controls the operating guide to disappear from the touch screen 170 if a user releases his or her finger from the touch screen 170. Alternatively, according to aspects of the present invention, the user touches the touch screen 170 with a stylus or other pointed device. According to aspects of the present invention, the operating guide is displayed as a GUI using arrow graphics, wherein functions correspond to each respective arrow graphic, as will be explained in detail with reference to FIGS. 5 and 6. However, it is understood that other graphics can be used in addition or instead of the shown arrow.

The control unit 160 causes the operating guide to represent functions which may be performed according to the direction in which the user's finger flicks over the touch screen 170. For example, the control unit 160 may control the touch screen 170 to display the operating guide so that if a user flicks his or her finger on the touch screen 170 upward, the touch screen 170 scrolls up; if a user flicks his or her finger on the touch screen 170 downward, the touch screen 170 scrolls down; if a user flicks his or her finger on the touch screen 170 to the left, a higher menu than the current menu appears on the touch screen 170; and if a user flicks his or her finger on the touch screen 170 to the right, an MP3 file is played back. The operating guide may also provide information on functions performed by the user flicking his or her finger diagonally, instead of up, down, left, or right. Further, according to aspects of the present invention, the flick may be just a movement of the user's finger across the touch screen 170, the speed of which may be adjusted by the user such that the control unit 160 may recognize flicks of differing speeds to perform different functions or the same function but associated with a slower or faster flick. Additionally, according to aspects of the present invention, the control unit 160 may recognize differing user's touching movements, such as a circle, or recognize multiple flicks to access one function, such as two flicks in an “X” pattern or an “III” pattern to access one function.

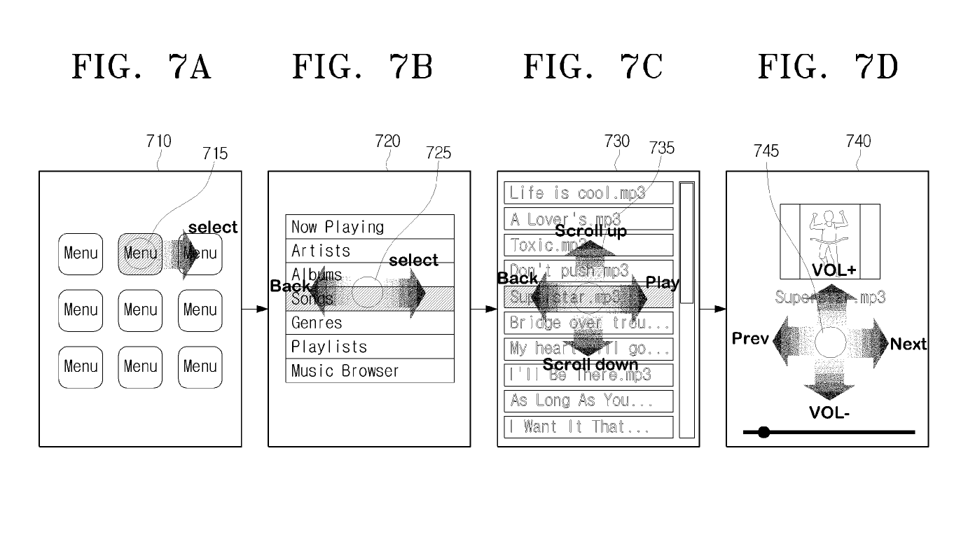

The control unit 160 controls the operating guide to provide information on functions which are supported in a current mode of an application, and therefore, the minimum number of operating methods may be displayed on the operating guide. Accordingly, a user may determine which functions are supplied by the current mode of the application supports, as will be explained in detail with reference FIGS. 7A to 7D.

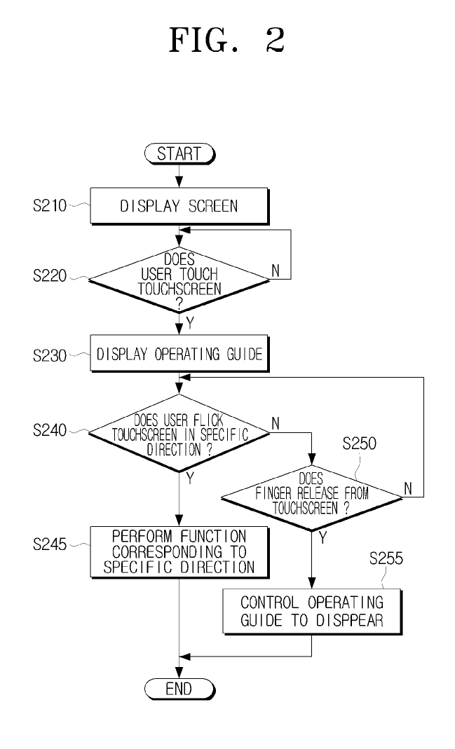

Hereinbelow, the process of displaying an operating guide will be explained in detail with reference to FIG. 2. FIG. 2 is a flowchart illustrating the process of providing an operating guide according to an exemplary embodiment of the present invention.

The control unit 160 controls the touch screen 170 to display a current screen (S210). For example, a main screen, a category list, a music file list, or a music play back screen may be displayed on the touch screen 170 of the MP3 player. Aspects of the present invention are not limited thereto such that files other than multimedia files as well as networks or other devices may be displayed on the touch screen 170.

The control unit 160 determines whether a user touches the touch screen 170 (S220). If the user has not touched the touch screen 170, the process returns to S220 in S220-N. If the user touches the touch screen 170 (S220-Y), the control unit 160 displays an operating guide at the touched location of the touch screen 170 (S230). The user knows that the MP3 player is operated differently according to the directions in which the user flicks his or her finger on the touch screen 170.

The control unit 160 determines whether the user flicks his or her finger on the touch screen 170 in a specific direction (S240). If a user flicks his or her finger on the touch screen 170 in a specific direction (S240-Y), the control unit 160 controls the MP3 player to perform the function corresponding to the direction in which the touch screen 170 is flicked (S245). Further, although described as a specific direction, aspects of the present invention are not limited thereto such that the control unit 160 may determine whether the user taps or plurally flicks the touch screen 170, or the like.

As a non-limiting example, if a current application is in a mode for displaying a music file list, the control unit 160 controls the MP3 player so that if a user flicks his or her finger on the touch screen 170 upward, the music file list scrolls up; if a user flicks his or her finger on the touch screen 170 downward, the music file list scrolls down; if a user flicks his or her finger on the touch screen 170 to the left; a higher menu than the music file list is displayed; and if a user flicks his or her finger on the touch screen 170 to the right, an MP3 file is played back. Further, aspects of the present invention are not limited thereto such that a user may determine the functions corresponding to the input flicks.

According to aspects of the present invention, if a user does not flick his or her finger in any direction on the touch screen 170 (S240-N), and releases his or her finger from the touch screen 170 (S250-Y), the control unit 160 controls the operating guide to disappear from the touch screen 170 (S255). As such, according to aspects of the present invention, the operating guide is displayed on the touch screen 170 while the user keeps his or her finger touching the touch screen 170. The control unit 160 displays the operating guide on the touch screen 170 according to the process described above. If the user does not release from the touch screen 170 in S250, the process returns to operation S240 in S250-N.

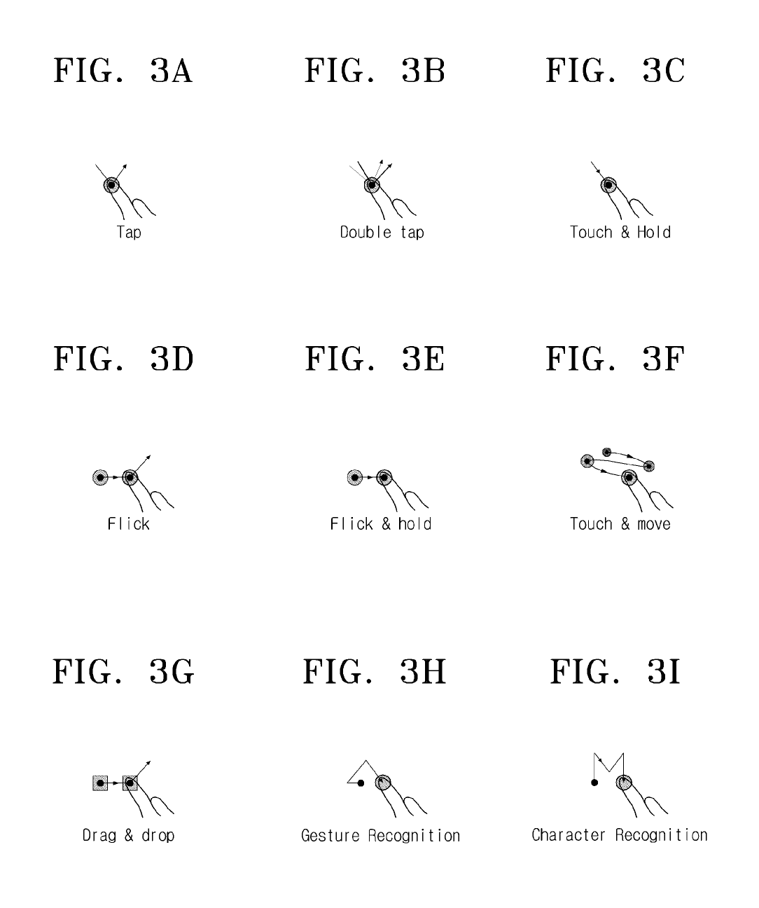

Hereinbelow, methods of touching the touch screen 170 will be explained with reference to FIGS. 3A through 3I. FIGS. 3A through 3I are diagrams illustrating touch operations of a touch screen according to aspects of the present invention. Referring to FIGS. 3A through 3I, the methods of touching the touch screen 170 may include tap, double tap, touch and hold, flick, flick and hold, touch and move, and drag and drop actions, gesture recognition, and character recognition. However, aspects of the present invention are not limited thereto such that other touchings of the touch screen 170 may be included.

A tap action (FIG. 3A) is an action in which a user touches the touch screen 170 with his or her finger once for a short time and releases his or her finger from the touch screen 170. Tapping may perform a function corresponding to that of clicking a mouse button.

A double tap action (FIG. 3B) is an action in which a user touches the same location of the touch screen 170 twice in quick succession with his or her finger. Double tapping may perform a function corresponding to that of double-clicking a mouse button.

A touch and hold action (FIG. 3C) is an action in which a user touches the touch screen 170 with his or her finger for a predetermined time period. The touch and hold action may perform a function corresponding to that of pressing a mouse button for a predetermined time period.

A flick action (FIG. 3D) is an action in which a user moves his or her finger in a specific direction while touching the touch screen 170 and releases his or her finger from the touch screen 170. Flicking can also be referred to as stroking.

A flick and hold action (FIG. 3E) is an action in which a user moves his or her finger in a specific direction while touching the touch screen 170, and keeps his or her finger on the touch screen 170.

A touch and move action (FIG. 3F) is an action in which a user moves his or her finger in a non-specific direction while touching the touch screen 170.

A drag and drop action (FIG. 3G) is an action in which a user clicks an item displayed on the touch screen 170 and drags the item to a different location or onto another item. The drag and drop action is similar to the action of dragging an item using a mouse.

Gesture recognition (FIG. 3H) refers to a user performing a specific movement with his or her finger corresponding to a predetermined gesture on the touch screen 170. For example, if a user draws a triangle on the touch screen 170, the touch screen 170 notifies the control unit 160 that a triangle is input. Aspects of the present invention allow a user to define such gestures.

Character recognition (FIG. 3I) refers to a user writing a word or letter corresponding to a predetermined word or letter on the touch screen 170. For example, if a user writes a letter “M” on the touch screen 170, the touch screen 170 notifies the control unit 160 that the letter “M” is input.

As described above, various input methods are provided using the touch screen 170. Various types of input methods other than the above methods may also be used.

Since there are various types of input methods, a user may not be able to remember all the different functions available for each input method. Accordingly, the user can easily see what functions are available for each input method by viewing the operating guide.

In the exemplary embodiment of the present invention, the flicking represents an action in which a user moves his or her finger in a specific direction while touching the touch screen 170 and releases his or her finger from the touch screen 170. However, flicking may also be referred to by other terms.

The term “flicking” used herein includes the flick, flick and hold, and touch and move actions shown in FIGS. 3D through 3F. Flicking may be any other action in which a user flicks or strokes his or her finger across the touch screen 170 while touching the touch screen 170.

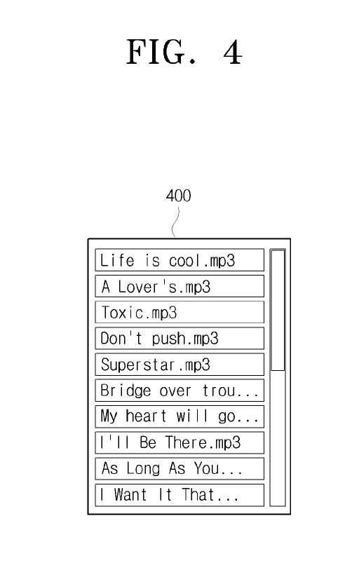

Hereinafter, various types of operating guides will be explained in detail with reference to FIGS. 4 to 6. FIG. 4 is a view illustrating the touch screen 170 prior to being touched by a user according to an exemplary embodiment of the present invention. In FIG. 4, a music file list 400 is displayed on the touch screen 170. If a user does not touch the touch screen 170, only the music file list 400 is displayed on the touch screen 170. Aspects of the present invention are not limited to the displaying of the music file list 400 as described above.

FIG. 5 is a view illustrating the touch screen 170 displaying an operating guide according to an exemplary embodiment of the present invention. Referring to FIG. 5, if a user touches the touch screen 170, a music file 510 which a user touches in the music file list 400 is highlighted. An operating guide 520 is displayed as four directional arrows centered on the location where the user touches an area of the touch screen 170 with his or her finger. The functions corresponding to each arrow are displayed at each edge of the four directional arrows. As shown, the highlighted file 510 is Superstar.mp3, whereas the remaining files are not highlighted. However, it is understood that multiple files could be selected/highlighted in other aspects.

In FIG. 5, the music file list 400 is displayed semitransparently, and the operating guide 520 is displayed opaquely. Alternatively, the music file list 400 may be displayed opaquely, and the operating guide 520 may be displayed semitransparently.

Referring to FIG. 5, “scroll up” is displayed adjacent to an up arrow; “scroll down” is displayed adjacent to a down arrow; “back” is displayed adjacent to a left arrow; and “play” is displayed adjacent to a right arrow. That is, the operating guide 520 informs that if the user flicks the touch screen 170 upward, the music file list 400 scrolls up; if the user flicks the touch screen 170 downward, the music file list 400 scrolls down; if the user flicks the touch screen 170 to the left, a higher menu than the music file list 400 appears; and if the user flicks the touch screen 170 to the right, an MP3 file is played back. However, the functions associated with the arrows are not limited thereto such that a user may define which of the functions correspond with the arrows. Further, the directions need not be orthogonal as shown and can be curvilinear.

While the operating guide 520 in FIG. 5 is displayed so that functions are displayed adjacent to corresponding direction arrows, the operating guide 520 may be displayed using other forms. Another form will be explained with reference to FIG. 6.

FIG. 6 is a view illustrating a touch screen 170 displaying an operating guide according to an exemplary embodiment of the present invention. Referring to FIG. 6, if a user selects a desired music file 610 by touching the touch screen 170, an operating guide 620 is displayed as four directional arrows centered on the location where the user touches an area of the touch screen 170 with his or her finger, and the functions corresponding to each arrow are displayed in a guide area 630 disposed at the bottom of the music file list 400. Aspects of the present invention are not limited thereto such that the guide area 630 may be displayed on a side of or at the top of the music file list 400, and the location of the guide area 630 may be determinable by the user.

When the functions corresponding to each arrow are displayed in the separate guide area 630, the functions do not overlap with the music file list 400, so a user can see the functions more clearly. While described as being below, it is understood that the guide area 630 can be disposed in other locations not overlapping the music file list 400, such as above or to the side.

An operating guide may be displayed differently according to the mode of an application, which will be explained with reference to FIGS. 7A through 7D. FIGS. 7A through 7D are views illustrating the process of operating a touch screen 170 according to an exemplary embodiment of the present invention. Referring to FIGS. 7A through 7D, four modes of an application are provided, including a main screen mode 710, a category list mode 720, a music file list mode 730, and a music playback mode 740. However, aspects of the present invention are not limited thereto.

In the main screen mode 710 of FIG. 7A, various menus, which the MP3 player supports, are displayed. The selection of a menu is made in the main screen mode 710. Accordingly, if a user touches the touch screen 170, an operating guide 715 including a right arrow and a command “select” is displayed on the touch screen 170. In the main screen mode 710, if a user touches one of the menus on the touch screen 170, and flicks the touch screen 170 to the right, the menu is selected and a list including sub-menus of the selected menu is displayed on the touch screen 170.

If a user selects a menu for listening to music in the main screen mode 710, the mode of the MP3 player changes from the main screen mode 710 to the category list mode 720 of FIG. 7B. In the category list mode 720, categories for selecting a music file are displayed. For example, “artists,” “albums,” “songs,” “genres,” “play lists,” and the like are displayed in a list.

The category list mode 720 has a menu selection function and a function of returning to a higher menu. Accordingly, if a user touches the touch screen 170 in the category list mode 720, an operating guide 725 is displayed on the touch screen 170, including left and right arrows and commands “back” and “select”. If a user selects “songs,” and flicks the touch screen 170 to the right, the mode of the MP3 player changes from the category list mode 720 to the music file list mode 730 of FIG. 7C.

In the music file list mode 730, music files are provided in a list. The music file list mode 730 has functions of scrolling up the music file list, scrolling down the music file list, returning to a higher menu, and a playback function. If a user touches the touch screen 170 in the music file list mode 730, an operating guide 735 is displayed on the touch screen 170 including four arrows, and the commands “scroll up,” “scroll down,” “back,” and “play” adjacent to the up, down, left, and right arrows respectively. Again, aspects of the present invention are not limited thereto such that the arrows may correspond to other or user-defined functions.

If a user selects a music file by touching an area on which the music file is displayed, and flicks the touch screen 170 to the right, the selected music file is played back. In the music playback mode 740 of FIG. 7D, a selected music file is played back. The music playback mode 740 has functions of increasing and decreasing the music volume, and playing back a previous or subsequent track. If a user touches the touch screen 170 in the music playback mode 740, an operating guide 745 is displayed on the touch screen 170 including four arrows, and commands “Vol+,” “Vol−,” “Prev,” and “Next” adjacent to the up, down, left, and right arrows respectively. However, aspects of the present invention are not limited thereto such that the arrows may correspond to other or user-defined functions. Further, such functions are not limited to the playback of music in the music playback mode 740, such the functions may be applied to a video playback mode or sorting through various files.

As the operating guide displays the functions which a current mode of an application supports, a user can know the currently supported functions, and operate the MP3 player conveniently and simply.

While an operating guide having up, down, left, and right directions is displayed in the exemplary embodiment of the present invention, any other direction may also be included. For example, an operating guide may have functions corresponding to eight, including diagonal directions in addition to up, down, left, and right directions, or more directions.

An operating guide may also have distinct functions for clockwise and counterclockwise flicking actions. For example, the operating guide may include a clockwise arrow, a counterclockwise arrow, and commands “scroll up,” and “scroll down” may be displayed adjacent to the arrows.

The MP3 player is provided as an example of a multimedia apparatus in the exemplary embodiment of the present invention, but the present invention may also be applied to any other multimedia apparatuses having a touch screen, such as a portable media player (PMP), a mobile phone, a laptop or a tablet computer, a camera, an electronic dictionary, a personal digital assistant (PDA), a remote control, or the like.

As described above, according to the exemplary embodiments of the present invention, a method for providing a UI to display a guide representing functions performed differently according to a user's operation, and a multimedia apparatus using the same are provided. Accordingly, a user may use a touch screen more conveniently.

If a user touches a touch screen, an operating guide is displayed. The user can thus use a multimedia apparatus conveniently by viewing the operating guide on the touch screen without needing to memorize all the functions of the multimedia apparatus.

As an operating guide to be supplied in a current mode of an application is displayed, a user can use the functions provided differently according to the mode of a multimedia apparatus appropriately without memorizing the various functions. While not require, aspects of the invention can be implemented using software and/or firmware encoded in computer readable media to be implemented by one or more processors and/or computers.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A method of providing a user interface (UI), the method comprising:
receiving a touch from a user on a touch screen; and
displaying an operating guide which describes functions performable according to types of touches on the touch screen upon the receiving of the touch from the user.

2. The method of claim 1, wherein the operating guide represents functions performable according to a direction in which the user flicks the touch screen, the flick being one of the types of touches in which a user touches the touch screen and flicks in the direction to access the function to be performed according to the direction.

3. The method of claim 2, wherein the direction is selectable between up, down, left, and right directions.

4. The method of claim 1, wherein the displaying of the operating guide comprises:
displaying the operating guide corresponding to an area in which the touch screen is touched.

5. The method of claim 1, wherein the displaying of the operating guide comprises:
displaying the operating guide on the touch screen while the touch screen is touched.

6. The method of claim 1, further comprising:
performing a function corresponding to a predetermined direction if the user flicks the touch screen in the predetermined direction.

7. The method of claim 1, further comprising:
causing the operating guide to disappear if the user releases his or her finger from the touch screen.

8. The method of claim 1, wherein the operating guide represents functions corresponding to a current mode of an application.

9. The method of claim 1, wherein the types of touches on the touch screen comprise: a tap, a double tap, a touch and hold, a flick, a flick and hold, a touch and move, a drag and drop action, a gesture, and a character.

10. The method of claim 1, wherein the displaying of the operating guide comprises displaying names of the represented performable functions.

11. The method of claim 10, wherein the displaying of the names of the represented functions to be performed comprises displaying the names in an area disposed away from the touch on the touch screen.

12. The method of claim 10, wherein the displaying of the names of the represented functions to be performed comprises displaying the names near an edge of the touch screen.

13. The method of claim 2, wherein the displaying of the operating guide comprises displaying names of the represented functions to be performed adjacent to the direction in which the user flicks to access the function to be performed.

14. A computer readable recording medium having recorded thereon a program to execute the method of claim 1 as implemented by one or more computers.

15. A multimedia apparatus, comprising:
a touch screen to display a user interface and to receive a user's touch; and
a control unit to control the touch screen to display an operating guide which describes functions performable according to types of touches if the user's touch is received on the touch screen.

16. The apparatus of claim 15, wherein the operating guide represents functions to be performed according to a direction in which a user flicks the touch screen, the flick being one of the types of the touch in which a user touches the touch screen and flicks in the direction to access the function to be performed according to the direction.

17. The apparatus of claim 16, wherein the direction is selectable between up, down, left, and right directions.

18. The apparatus of claim 15, wherein the control unit controls the touch screen to display the operating guide corresponding to an area in which the touch screen is touched.

19. The apparatus of claim 15, wherein the control unit controls the touch screen to display the operating guide while the touch screen is touched.

20. The apparatus of claim 15, wherein, if a user flicks the touch screen in a predetermined direction, the control unit controls the touch screen to perform a function corresponding to the predetermined direction.

21. The apparatus of claim 15, wherein, if the user releases his or her finger from the touch screen, the control unit causes the operating guide to disappear.

22. The apparatus of claim 15, wherein the operating guide represents functions corresponding to a current mode of an application.

23. A method of providing a user interface (UI), the method comprising:
detecting a touch of a touch screen;
displaying an operating guide upon the detecting of the touch, the operating guide providing information on directions to touch the touch screen to activate corresponding functions;
detecting a direction of the touch of the touch screen on which the operating guide is displayed; and
performing one of the functions corresponding to the detected direction of the touch.

24. The method of claim 23, further comprising detecting a release of the touch from the touch screen and stopping the displaying of the operating guide upon the detecting of the release.

25. The method of claim 23, wherein the detecting of the direction of the touch comprises detecting a flick, a flick and hold, a touch and move, a drag and drop, a gesture, and a character.

26. The method of claim 23, wherein the information of the operating guide comprises names of the functions corresponding to the direction.

27. A method of providing a user interface (UI), the method comprising:
detecting a first touch of a touch screen;
displaying a first operating guide corresponding to a first mode upon the detecting of the touch, the first operating guide providing information on performable functions corresponding to the first mode, one of the performable functions being to switch to a second mode;
detecting a direction of the touch of the touch screen on which the first operating guide is displayed; and
displaying the second mode corresponding to the detected direction of the touch.

28. The method of claim 27, further comprising:
detecting a second touch of the touch screen;
displaying a second operating guide corresponding to a second mode, the second operating guide providing information on performable functions corresponding to the second mode.

29. The method of claim 27, wherein the performable functions corresponding to the first operating guide are different from the performable function corresponding to the second operating guide.
